(19) United States
(12) Patent Application Publication
(10) Pub. No.: US 2024/0070396 A1
(43) Pub. Date: Feb. 29, 2024

(54) Method for Determining Candidate Company Related to News and Apparatus for Performing the Method

(71) Applicant: FiscalNote, Inc., Washington WASHINGTON, DC (US)

(72) Inventors: Byoung Kyu Yoo, Goyang-si (KR); Hyun Gil Jeong, Seongnam-si (KR); Min Hyung So, Seoul (KR); Joon Ik Lee, Seoul (KR)

(21) Appl. No.: 18/354,647

(22) Filed: Jul. 19, 2023

Related U.S. Application Data
(63) Continuation-in-part of application No. 18/350,737, filed on Jul. 11, 2023.

(30) Foreign Application Priority Data
Jul. 13, 2022 (KR) 10-2022-0086197
Jul. 19, 2022 (KR) 10-2022-0088808
Jul. 25, 2022 (KR) 10-2022-0091689
Jul. 29, 2022 (KR) 10-2022-0094512

(51) Int. Cl. G06F 40/295; G06F 40/247; G06F 40/284

(52) U.S. Cl. CPC G06F 40/295; G06F 40/247; G06F 40/284; H04N 21/4886

(57) ABSTRACT

The present invention relates to a method of determining a candidate company related to news and an apparatus for performing the method. The method of determining a candidate company related to news, comprises determining, by a news ticker mapping apparatus, an entity name for news and determining, by the news ticker mapping apparatus, a candidate ticker on the basis of the entity name.

### BACKGROUND

### 1. Field of the Invention

The present invention relates to a method of determining a candidate company related to news and an apparatus for performing the method. More specifically, the present invention relates to a method of determining a candidate company related to news for determining the candidate company related to the news, and an apparatus for performing the method.

### 2. Discussion of Related Art

With the development of the Internet, information is actively shared and the amount of data is increasing. Data on the Internet, such as news articles, blogs, and web documents that anyone can easily access as well as professionally handled documents that cannot be handled by the general public, are increased in the internal system by field. As the speed and volume of data appearing on the Internet increase, data analysis technology based on artificial intelligence rather than human analysis is being developed.

In the conventional technology, a technology for searching for and collecting news using only a company name as a keyword and providing a summary is disclosed (Korean application number: 1020200055691, patent title: Method of providing company news). There is a problem with this method in that news that does not include a company name cannot be collected. Further, in a news crawling system and a news crawling method (Korean application number: 102020012346), there is a limitation in that, even when duplicate news can be removed from crawled news, only identical news with completely identical titles can be removed, and when the titles are similar in content but words in the titles are different, the news cannot be filtered as duplicate news.

### SUMMARY OF THE INVENTION

The present invention is directed to solving all of the above-described problems.

The present invention is also directed to providing a technique in which news is classified by company by classifying pieces of unspecified news by company and removing duplicate news so that a user can efficiently identify news related to a specific company.

The present invention is also directed to providing a technique in which entity name linking, which is a natural language processing technology, and indexing of elastic search can be used to map news collected using various keywords to a company when the news is relevant even when a company name is not in the news.

A representative configuration of the present invention for achieving the above objects is as follows.

According to an aspect of the present invention, there is provided a method of determining a candidate company related to news comprises determining, by a news ticker mapping apparatus, an entity name for news; and determining, by the news ticker mapping apparatus, a candidate ticker on the basis of the entity name.

Meanwhile, the entity name includes a first entity name and a second entity name, and the candidate ticker is determined based on a keyword determined based on the first entity name and info determined based on the second entity name.

Further, the candidate ticker is determined based on synonym expansion for the keyword and relationship information-based expansion for the info, and the relationship information-based expansion is determined based on a knowledge graph.

According to another aspect of the present invention, there is provided a news ticker mapping apparatus for determining a candidate company related to news, comprises an entity name extraction unit configured to determine an entity name for news; and a candidate ticker determination unit configured to determine a candidate ticker on the basis of the entity name.

Meanwhile, the entity name includes a first entity name and a second entity name, and the candidate ticker is determined based on a keyword determined based on the first entity name and info determined based on the second entity name.

Further, the candidate ticker is determined based on synonym expansion for the keyword and relationship information-based expansion for the info, and the relationship information-based expansion is determined based on a knowledge graph.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram illustrating a news ticker mapping apparatus according to an embodiment of the present invention.

FIG. 2 is a conceptual diagram illustrating the operation of the entity name extraction unit according to the embodiment of the present invention.

FIG. 3 is a conceptual diagram illustrating the operation of the candidate ticker determination unit according to the embodiment of the present invention.

FIG. 4 is a conceptual diagram illustrating the operation of the candidate ticker score determination unit according to the embodiment of the present invention.

FIG. 5 is a conceptual diagram illustrating the operation of the news ticker determination unit according to the embodiment of the present invention.

FIG. 6 is a conceptual diagram illustrating the operation of the news clustering unit according to the embodiment of the present invention.

FIG. 7 is a conceptual diagram illustrating the operation of the entity name extraction unit according to the embodiment of the present invention.

FIG. 8 is a conceptual diagram illustrating a knowledge graph according to the embodiment of the present invention.

FIG. 9 is a conceptual diagram illustrating a knowledge graph according to the embodiment of the present invention.

FIG. 10 is a conceptual diagram illustrating the operation of the candidate ticker score determination unit according to the embodiment of the present invention.

FIG. 11 is a conceptual diagram illustrating a method of determining, by the candidate ticker score determination unit according to the embodiment of the present invention, vector values.

FIG. 12 is a conceptual diagram illustrating a method of determining candidate ticker scores according to the embodiment of the present invention.

FIG. 13 is a conceptual diagram illustrating an operation of the role determination model according to the embodiment of the present invention.

FIG. 14 is a conceptual diagram illustrating a clustering operation of the news clustering unit according to the embodiment of the present invention.

FIG. 15 is a conceptual diagram illustrating clustering according to the embodiment of the present invention.

### DETAILED DESCRIPTION OF EXEMPLARY EMBODIMENTS

The detailed description of the present invention will be made with reference to the accompanying drawings showing examples of specific embodiments of the present invention. These embodiments will be described in detail such that the present invention can be performed by those skilled in the art. It should be understood that various embodiments of the present invention are different but are not necessarily mutually exclusive. For example, a specific shape, structure, and characteristic of an embodiment described herein may be implemented in another embodiment without departing from the scope and spirit of the present invention. In addition, it should be understood that a position or arrangement of each component in each disclosed embodiment may be changed without departing from the scope and spirit of the present invention. Accordingly, there is no intent to limit the present invention to the detailed description to be described below. The scope of the present invention is defined by the appended claims and encompasses all equivalents that fall within the scope of the appended claims. Like reference numerals refer to the same or like elements throughout the description of the figures.

Hereinafter, in order to enable those skilled in the art to practice the present invention, exemplary embodiments of the present invention will be described in detail with reference to the accompanying drawings.

A news ticker mapping method according to an embodiment of the present invention is a method in which entity name linking, which is a natural language processing technology, and indexing of elastic search can be used to map news collected using various keywords to a company when the news is relevant even when a company name is not in the news. Based on this method, more various types of news may be collected and effectively provided to users.

In the present invention, the term “ticker” may be used as an example of an identifier indicating a company. In the present invention, the term “ticker” may be interpreted as a term that refers to an identifier of an object in order to link not only a company but also text and other objects.

That is, as an example of the news ticker mapping method according to the embodiment of the present invention, a method of matching news and a company ticker is described for convenience of description, but the news ticker mapping method according to the embodiment of the present invention is a method of matching structured or unstructured data with a specific object and may be used for general purposes, and such an example may be included in the scope of the present invention.

Conventional news providing systems may only collect news that includes correct company names. Therefore, when a correct company name is not included in news, it is difficult to show the news as news for the corresponding company. In addition, since the conventional news providing system collects news simply because the corresponding company name is included, the degree of correlation between the collected news and the company may not be high.

Therefore, in the news ticker mapping method according to the embodiment of the present invention, in order to collect news using various keywords, news and tickers may be mapped by adding not only company names, but also various keywords appearing in a company's subsidiaries, brands, electronic disclosures, and public data to an elastic search engine. That is, news may be collected using various keywords, and even when a correct company name is not included in the news, the news may be mapped to a specific company and provided to a user.

Further, in the news ticker mapping method according to the embodiment of the present invention, by combining elastic search and entity name linking, which is a natural language processing technology using deep learning, it is possible to classify which keyword among overlapping keywords corresponds to a company related to a specific piece of news.

In addition, in the news ticker mapping method according to the embodiment of the present invention, similar news may be grouped into one cluster through news clustering, and thus news that is distributed redundantly by multiple news media may be easily managed.

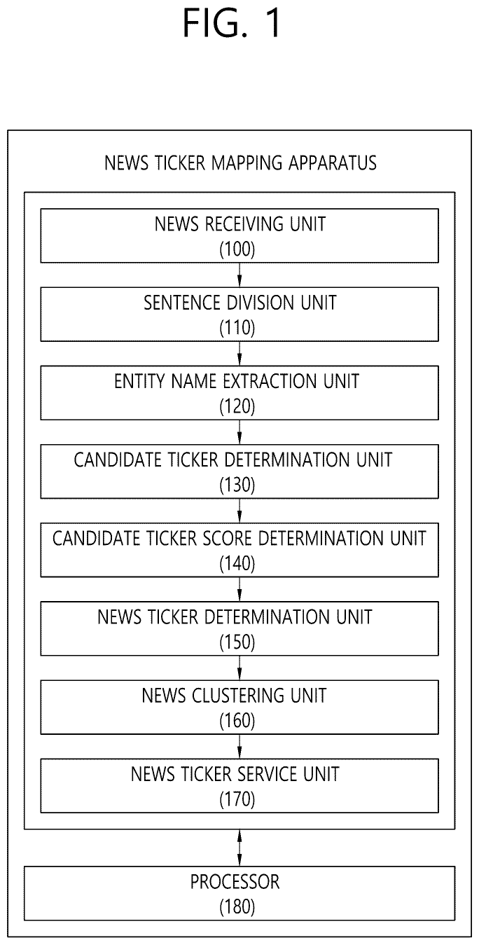

FIG. 1 is a conceptual diagram illustrating a news ticker mapping apparatus according to an embodiment of the present invention.

In FIG. 1, a method of mapping news input by the news ticker mapping apparatus with a company ticker corresponding to a company is disclosed.

Referring to FIG. 1, the news ticker mapping apparatus may include a news receiving unit 100, a sentence division unit 110, an entity name extraction unit 120, a candidate ticker determination unit 130, a candidate ticker score determination unit 140, a news ticker determination unit 150, a news clustering unit 160, and a news ticker service unit 170.

The news receiving unit 100 may be implemented to receive news that is a subject of analysis. The news receiving unit 100 may be implemented to collect pieces of unspecified news on the basis of various keywords.

The sentence division unit 110 may be implemented to divide text constituting the news into units of sentences.

The entity name extraction unit 120 may be implemented to extract an entity name after determining whether an extracted sentence has the entity name on the basis of named entity recognition (NER), which is a natural language processing technology. The entity name extraction unit 120 may be implemented to recognize, extract, and classify entity names corresponding to n tags for finding a company ticker in the sentence.

The candidate ticker determination unit 130 may be implemented to determine candidate tickers on the basis of an elastic search engine.

The candidate ticker score determination unit 140 may be implemented to determine a candidate ticker score for each of one or more candidate tickers determined by the candidate ticker determination unit 130. Further, the candidate ticker score determination unit 140 may determine a sentence ticker, which is a ticker corresponding to the sentence, on the basis of the candidate ticker score for each of one or more candidate tickers. For example, among the candidate ticker scores, a candidate ticker score that exceeds a threshold score may be determined to be the sentence ticker.

The news ticker determination unit 150 may determine a news ticker corresponding to the news on the basis of a sentence ticker for each of a plurality of sentences constituting the news. For example, the news ticker determination unit 150 may determine the corresponding sentence ticker to be the news ticker only when the ticker score exceeds a threshold value. The news ticker may be a company ticker corresponding to the news.

The news clustering unit 160 may be implemented to determine whether news is duplicated based on clustering. For example, the news clustering unit 160 may group pieces of duplicate news into one cluster by performing clustering on news that has an identical or similar news ticker corresponding to the news. The news clustering unit 160 may determine a morpheme vector value and a company vector value for the news, and form pieces of duplicate news into one cluster through clustering based on the morpheme vector value and the company vector value for the news.

The news ticker service unit 170 may be implemented to map and service news for a specific company.

The operations of the news receiving unit 100, the sentence division unit 110, the entity name extraction unit 120, the candidate ticker determination unit 130, the candidate ticker score determination unit 140, the news ticker determination unit 150, the news clustering unit 160, and the news ticker service unit 170 may be performed based on a processor 180.

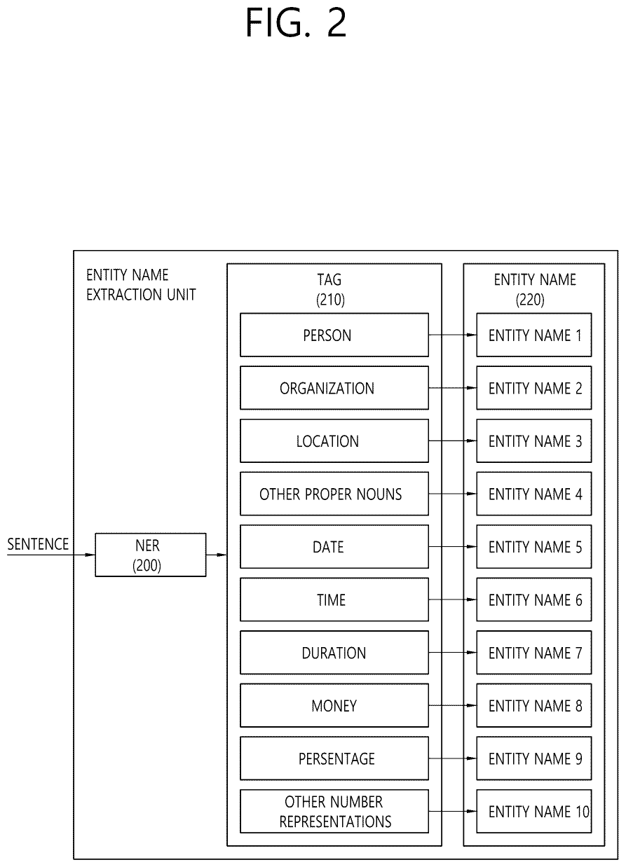

FIG. 2 is a conceptual diagram illustrating the operation of the entity name extraction unit according to the embodiment of the present invention.

In FIG. 2, entity name extraction and classification operations of the entity name extraction unit are disclosed.

Referring to FIG. 2, the entity name extraction unit checks whether an extracted sentence has an entity name on the basis of NER, which is a natural language processing technology.

In the NER 200 according to the embodiment of the present invention, entity names 220 corresponding to 10 tags 210 such as person, organization, location, other proper nouns, date, time, duration, money, percentage, and other number representations may be recognized, extracted, and classified in the sentence. The tags 210 used in the NER 200 according to the embodiment of the present invention are tags separately defined and used in the present invention to find a news ticker, which will be described below.

That is, in the present invention, in order to match news and a company by finding an entity name 220 of interest in the input sentence based on the NER 200, the entity names 220 may be found by generally setting objects such as people, organizations, geographical locations that are typically used in news text related to companies, noun expressions such as brand names, or the like as the tags 210.

The entity name extraction operation based on the above NER 200 may be performed on each of a plurality of sentences included in the entire news text. A specific NER operation will be described below.

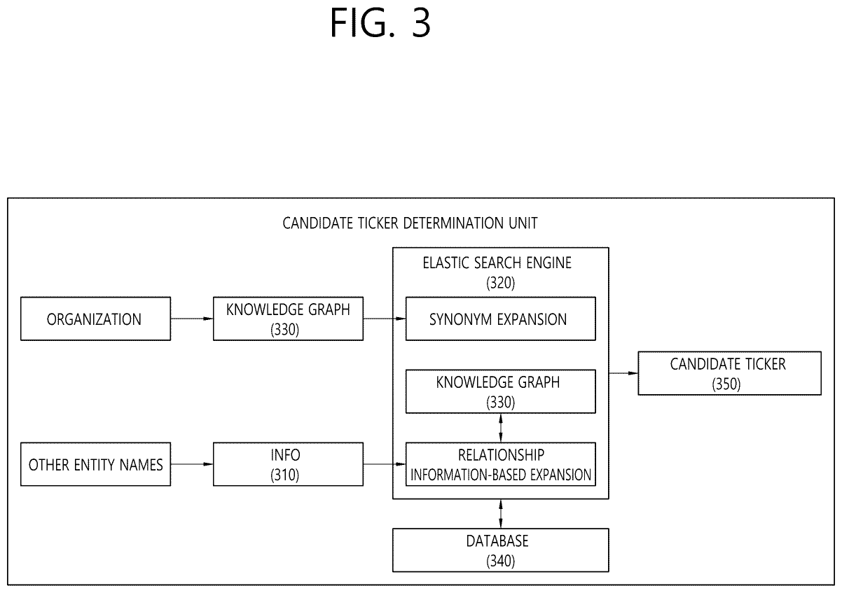

FIG. 3 is a conceptual diagram illustrating the operation of the candidate ticker determination unit according to the embodiment of the present invention.

In FIG. 3, an operation in which the candidate ticker determination unit determines candidate tickers on the basis of an elastic search engine is disclosed.

Referring to FIG. 3, the entity name determined by the entity name extraction unit may be classified into a keyword 300 and info 310 and input to an elastic search engine 320.

The keyword 300 may be a word corresponding to an entity name classified as an organization. The entity name for determining the keyword may be expressed as the term “first entity name.”

The info 310 may be a word corresponding to all entity names except for the entity name classified as the organization. The entity name for determining the info may be expressed as the term “second entity name.”

In other words, the entity name may include the first entity name and the second entity name, and the candidate tickers may be determined based on the keyword determined based on the first entity name and the info determined based on the second entity name.

The elastic search engine 320 may operate based on a database 340 built by indexing attribute information of unstructured and structured data collected from external servers such as an electronic disclosure system for company information (DART), public data, Wikipedia, and the like. Elastic Search is a search engine for providing a distributed real-time search and analysis engine that can be used to customize data search and analysis services through morphological analysis on the basis of a RESTful interface. Elastic Search is designed for cloud computing and has the characteristics of enabling real-time searches, being stable, reliable, fast, and easy to install.

The entity name obtained based on the entity name extraction unit may be classified into the keyword 300 or the info 310 and transmitted to the elastic search engine 320. The elastic search engine 320 may search the database 340 to determine candidate tickers 350 corresponding to the keyword 300 and the info 310. The candidate tickers 350 may be tickers of candidate companies corresponding to the sentence.

According to the embodiment of the present invention, the elastic search engine 320 may expand the keyword 300 to a synonym on the basis of the database 340, and expand the info 310 on the basis of relationship information.

For example, when the keyword 300 is “Samsung,” expansion to a synonym corresponding to “Samsung” corresponding to the keyword 300 may be performed. For example, the synonym of the keyword may be a word related to the keyword 300, such as “Samsung Electronics,” “Samsung C&T,” “Samsung Securities,” “Samjeon,” or “Samsung electronics.”

The info 310 may be used as relationship information for determining the candidate tickers 350. Various types of other additional information related to the company may form a knowledge graph 330, and whether information corresponding to the info 310 is related to a specific keyword (i.e., company) may be checked based on the knowledge graph 330.

For example, when “Jaeyong Lee” is present in the entity names as a person, the info 310 may be used to determine a specific candidate ticker 350 on the basis of the knowledge graph 330 that “Jaeyong Lee=Samsung Electronics=Vice Chairman.”

The knowledge graph 330 may include an internal data knowledge graph and an external data knowledge graph.

The internal data knowledge graph is a company-specific knowledge graph generated by generating an ontology that meets semantic web standards to express standardized company attributes and relationship information between companies. The external data knowledge graph may be built by collecting external data (e.g., Wikipedia data) from an external server and parsing the corresponding data to extract attributes of headwords and information between headwords in order to expand the knowledge graph.

The knowledge graph may be determined from among the internal data knowledge graph and the external data knowledge graph by linking a plurality of internal data knowledge graphs and a plurality of external data knowledge graphs on the basis of linking through automatic and manual methods for the same object. The knowledge graph will be described below in detail.

The candidate ticker determination operation of the candidate ticker determination unit described above may be performed on each of a plurality of sentences included in the entire news text.

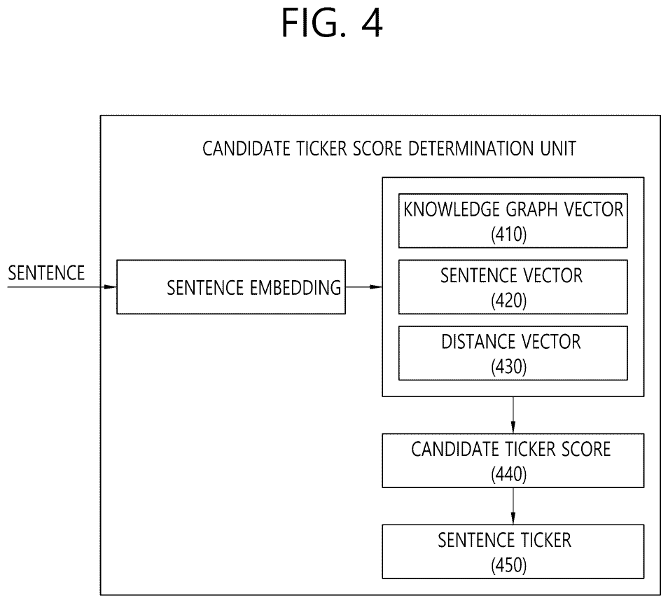

FIG. 4 is a conceptual diagram illustrating the operation of the candidate ticker score determination unit according to the embodiment of the present invention.

In FIG. 4, an operation in which the candidate ticker score determination unit determines scores for the candidate tickers determined by the candidate ticker determination unit is disclosed.

Referring to FIG. 4, the candidate tickers obtained based on the candidate ticker determination unit and information on the sentence may be transmitted to the candidate ticker score determination unit.

The candidate ticker score determination unit may determine a candidate ticker score for each of one or more candidate tickers in order to determine the candidate ticker (or a candidate ticker with a threshold score or higher) most related to the sentence as a sentence ticker.

The candidate ticker score determination unit may finally determine a candidate ticker score 440 for each candidate ticker on the basis of a knowledge graph vector 410, a sentence vector 420, and a distance vector 430. That is, one or more candidate tickers for each of a plurality of sentences may be determined, and the candidate ticker score 440 for each of the one or more candidate tickers may be determined.

The knowledge graph vector 410, the sentence vector 420, and the distance vector 430 will be described below in detail.

The candidate ticker score determination unit may determine the candidate ticker score on the basis of entity name linking. The entity name linking links an entity name within a sentence to a candidate ticker.

For example, “Samsung” used in the question “What is the CPU model used in the Galaxy S22 announced by Samsung?” refers to the company “Samsung Electronics.” In contrast, “Samsung” used in the news title “Samsung has become the second largest shareholder of an American exchange-traded fund (ETF) management company” refers to the company “Samsung Securities.” In this way, the meaning of an entity name with two or more meanings is determined by being related to the meanings of words commonly used in sentences. In this way, scores of the candidate tickers corresponding to the sentence may be determined in consideration of a relationship between the entity name and the candidate ticker.

The candidate ticker score determination unit may determine a sentence ticker 450 corresponding to the sentence on the basis of the plurality of candidate ticker scores 440 corresponding to the sentence. Hereinafter, the ticker corresponding to the sentence may be expressed as the term “sentence ticker 450.”

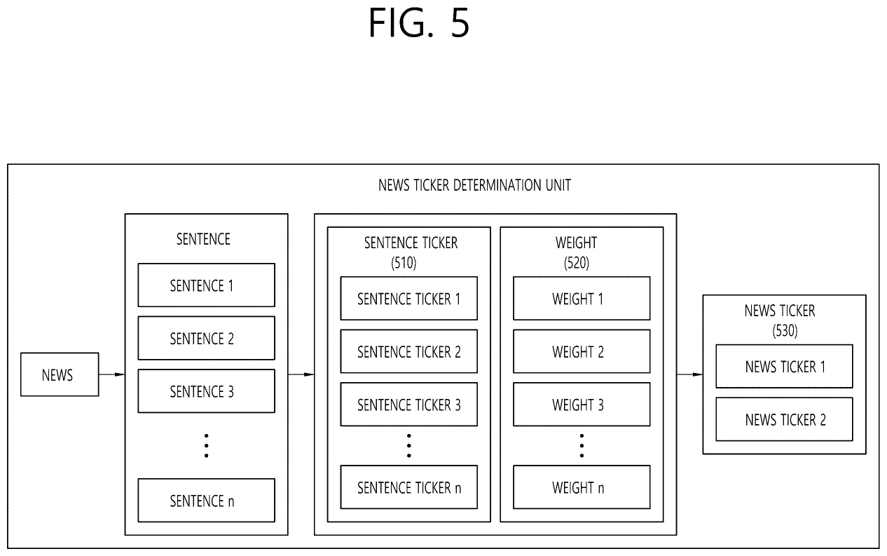

FIG. 5 is a conceptual diagram illustrating the operation of the news ticker determination unit according to the embodiment of the present invention.

In FIG. 5, an operation in which a heuristic entity score processing unit determines a news ticker corresponding to news on the basis of a sentence ticker corresponding to each of a plurality of sentences constituting the news (or news text) is disclosed.

Referring to FIG. 5, one piece of news may include a plurality of sentences. Therefore, sentence tickers 510 corresponding to the plurality of sentences constituting the news may be different. That is, when the news is analyzed based on the sentences, a type of company corresponding to one piece of news may vary. Therefore, in the present invention, a news ticker 530 for the news may be determined by giving different weights 520 according to locations of the sentences constituting the news to differentiate company scores.

Further, the highest level weight 520 may be assigned to a sentence ticker 510 corresponding to a title of the news, and a relatively high level weight 520 may be assigned to a sentence ticker 510 corresponding to a sentence included in a first paragraph or a last summary paragraph.

For example, in an article titled “Galaxy S22 launch,” a sentence ticker 510 corresponding to the title is “Samsung Electronics” and is a ticker corresponding to the news with a relatively high level weight 520, and thus a score of the sentence ticker 510 “Samsung Electronics” may be 96 points. Further, “Daedeok Electronics,” which is a sentence ticker 510 corresponding to a sentence included in the body of the same news, is a ticker corresponding to the news with a normal level weight 520, and thus a score of the sentence ticker 510 “Daedeok Electronics” may be 54 points.

The news ticker determination unit may determine the corresponding sentence ticker to be the news ticker 530 only when the score of the ticker exceeds a threshold value. A company corresponding to the news ticker 530 may be determined to be a company corresponding to the news.

Further, according to the embodiment of the present invention, the news ticker determination unit may additionally use a role determination model to classify an evaluator and an evaluation target within the sentence and determine the ticker corresponding to the news. For example, in the sentence “Samsung Securities raised the target price for Hynix,” “Samsung Securities” is an evaluator and “Hynix” is an evaluation target. Since news containing this sentence is more appropriate to be linked to a target company, “Hynix,” rather than to “Samsung Securities,” the role determination model is used to ensure the evaluator, “Samsung Securities,” is not linked to the corresponding sentence. A specific operation of the role determination model will be described below.

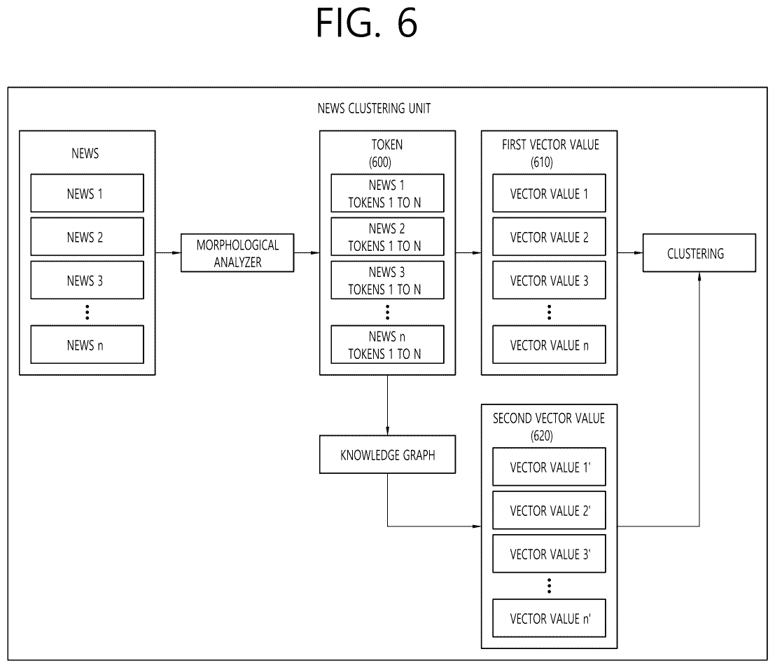

FIG. 6 is a conceptual diagram illustrating the operation of the news clustering unit according to the embodiment of the present invention.

In FIG. 6, a clustering operation in which the news clustering unit removes duplicate news is disclosed.

Referring to FIG. 6, the news clustering unit may determine a news ticker corresponding to the news and then perform news clustering to group pieces of duplicate news that overlap in content. The news clustering may be performed only on news with similar news tickers or may be performed on all the news.

The news clustering unit may generate news text in units of tokens using a morphological analyzer.

The plurality of generated tokens 600 may be vectorized using fasttext, and first vector values 610 of news may be determined based on an average value of vector values of the plurality of tokens. The first vector value 610 may be expressed as the term “morpheme vector value.”

Next, second vector values 620 of companies corresponding to the news may be determined using a knowledge graph. The second vector value 620 may be expressed as the term “company vector value.”

Clustering may be performed on a plurality of pieces of news on the basis of the first vector values 610 and the second vector values 620. The plurality of pieces of news determined as one cluster may be determined to be duplicate news. A method of determining a morpheme vector value and a company vector value and a method of clustering a morpheme vector value and a company vector value will be described below.

Through the methods, keywords that correspond to a company related to a piece of specific news are classified from among overlapping keywords. In addition, pieces of similar news are grouped into one cluster through news clustering, and thus news that is distributed redundantly by multiple news media may be easily managed. That is, news may be collected using various keywords, and even when a correct company name is not included in the news, the news may be mapped to a specific company and displayed to the user.

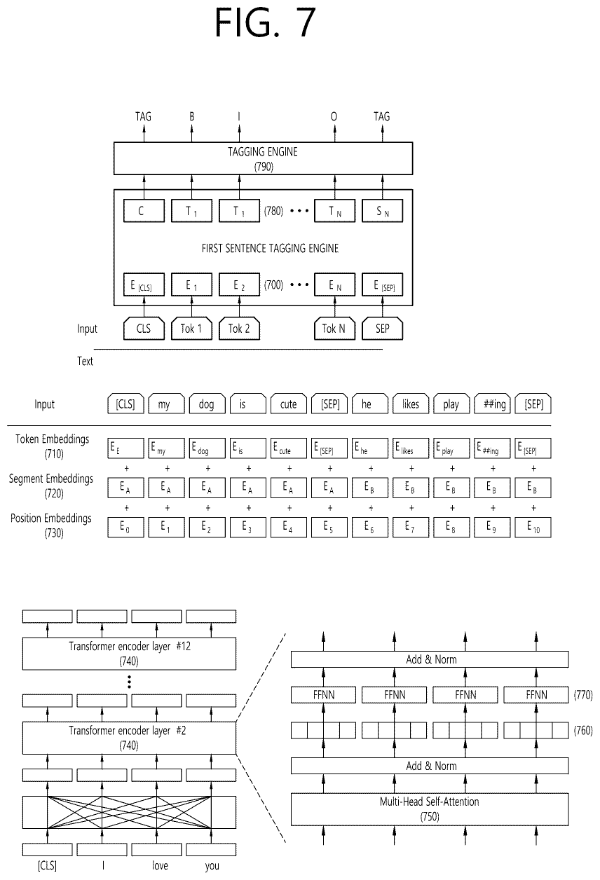

FIG. 7 is a conceptual diagram illustrating the operation of the entity name extraction unit according to the embodiment of the present invention.

In FIG. 7, an NER operation of the entity name extraction unit is disclosed.

Referring to FIG. 7, in the present invention, an E value of each token corresponding to an input sentence is a value generated by combining three embedding values.

Token embeddings 710 serving as first embeddings may form a sub-word of the longest length into one unit to determine a first embedding value using a sentence piece algorithm.

Segment embeddings 720 serving as second embeddings may determine a second embedding value through masking in units of sentences. A first sentence, Ea, is given a value of 0, and a subsequent sentence, E_{b}, is given a value of 1.

Position embeddings 730 serving as third embeddings may determine a third embedding value through position encoding using a sigmoid function in order to provide position information of an input token within the sentence.

The first embedding value, the second embedding value, and the third embedding value for each of the plurality of tokens may be added and used as an input vector 700 of a first sentence vectorization engine.

The first sentence vectorization engine is a model composed of N transformer encoder blocks. In the present invention, two models may be selectively used as the first sentence vectorization engine. Two first sentence vectorization engines are a base model or a large model. The base model consists of 12 transformer encoder layers, and the large model consists of 24 transformer encoder layers 740. The plurality of transformer encoder layers 740 perform a process of repeatedly encoding the meaning of the entire input value N times. The more transformer encoder layers 740 there are, the better the ability to capture complex relationships between words. However, when the number of transformer encoder layers 740 becomes too large, a problem occurs that the speed decreases. Therefore, optionally, the base model or the large model may be used. For example, when accuracy for each classification that is greater than or equal to a threshold accuracy is required, the large model may be used. Further, as the amount of total text included in the news relatively increases, noise increases and the large model may be used in consideration of such noise.

Hereinafter, for convenience of description, the base model will be mainly described.

As illustrated at the bottom of FIG. 7, the base model has a structure in which 12 transformer encoder layers 740 are stacked. Each transformer encoder layer 740 may be configured as illustrated at the bottom right of FIG. 7. Each transformer encoder layer 740 may include a multi-head self-attention 750 and feed-forward networks (FFNNs) 770.

The multi-head self-attention 750 of the transformer encoder layer 740 of the present invention is an attention with a plurality of heads. The multi-head self-attention 750 is a layer that calculates as many attentions as the number of heads using different attention weights and then concatenates the calculated attentions.

That is, vector values 760 reflecting the context is generated by referring to all input vectors 700 from E₁ to Eₙ through the multi-head self-attention 750. Then, these values pass through position-wise FFNNs 770. The FFNN 770 differentiates the corresponding vector value, obtains a gradient, and transmits the gradient using an activation function called GELU. The values obtained by each transformer encoder layer are transmitted to the next transformer encoder layer 740, and in the case of the base model, this process may be repeated a total of 12 times. Through this process, a T value of a final vector 780 corresponding to each of the plurality of input tokens may be determined.

The final vector 780 may be expressed as a tag and a BIO tag defined in the present invention through a tagging engine 790.

The BIO tag stands for B, which stands for begin, I, which stands for intermediate, and O, which stands for outside. For example, when a movie title is recognized, B is used for “Beom,” which is the beginning of a movie title like “Beom” (B), “Joe” (I), “Do” (I), “Si” (I), “Bol” (O), “KKa” (O), I is used until the end of the movie title, and O is used elsewhere. In this way, B and I are used for entity names, and O has the meaning that it is not an entity name.

The tagging engine 790 is an algorithm for directly calculating a probability that a result Y will occur, given data X. Model parameters of the tagging engine 790 of the present invention are learned to maximize an actual probability P(Y|X).

For example, in the case in which there is the sentence “Samsung (TAG1) Electronics (TAG2) of (TAG3) Hong-gil Dong (TAG4) Manager (TAG5),” it can be seen that when the tagging engine 790 is used, there is no tag B in front of TAG1 called “Samsung,” and thus a tag I is impossible. Therefore, tags B and O are possible with a probability of ½. When the tagging engine 790 is not used, tags B, I, and O are assigned a probability of ⅓ using only a T value, but when the tagging engine 790 is used, a probability of the BIO tag of the corresponding token may be calculated using the T value and BIO tag information of neighboring tokens.

In the present invention, some constraints given through the tagging engine 790 are as follows.

(1) I does not appear in a first word of a sentence.

(2) An O-I pattern does not appear.

(3) In a B-I-I pattern, entity names remain consistent. For example, ORG-I does not appear after PER-B.

A learning method for determining 10 tags defined in the present invention, such as person, organization, location, other proper nouns, date, time, duration, money, percentage, and other number representations, is disclosed.

Learning may be performed based on a learning dataset consisting of several sentences and entity names within the sentences. A total of 21 tags (+B and +I tags possible in 10 tags, O tag) may be defined. For example, tags such as PER-B, PER-I, ORG-B, ORG-I, and O may be defined.

When a specific sentence is input to an NER model of the present invention, the corresponding sentence is divided into units of tokens, passes through the first sentence vectorization engine and the tagging engine, and is given tags corresponding to the corresponding token. The tokens, which are given the tags, may be recombined from tags B to I to form one entity name. For example, “Samsung (ORG-B) j eon (ORG-I) j a (ORG-I) bujang (O) jigchaeg (O) hong (PER-B) gil-dong (PER-I)” may be determined to be “Samsung Electronics (ORG) Manager (O), Position (O), and Hong Gil-dong (PER).” The learning of the model proceeds in the direction in which the given entity name matches a correct answer dataset.

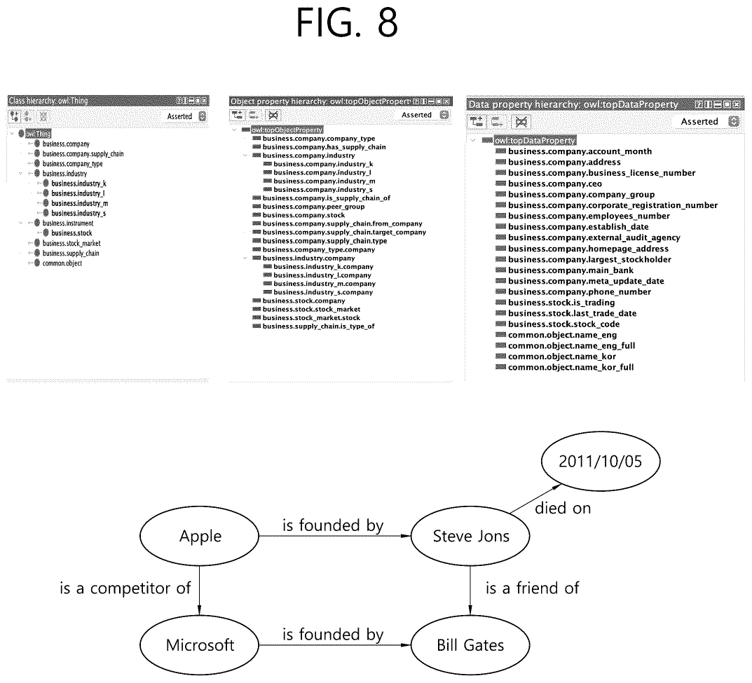

FIG. 8 is a conceptual diagram illustrating a knowledge graph according to the embodiment of the present invention.

In FIG. 8, a method of generating an internal data knowledge graph is disclosed.

Referring to FIG. 8, the internal data knowledge graph may be determined based on generation of an ontology that meets semantic web standards to express standardized company attributes and relationship information between companies.

A semantic web may enable semantic interpretation so that a computer can understand data on the web like humans. For example, the sentences “I was born on August 28th” and “My birthday is August 28th” are semantically identical, but the computer does not consider the sentences to be the same sentence. Therefore, the semantic web ontology may make the above two sentences identical. A knowledge graph may be built by defining an ontology and extracting data (I, was born, August 28th) and (My, birthday, August 28th) according to the ontology. Since an ontology defines the fact that “was born” and “birthday” have the same meaning, the computer may understand that the two pieces of data have the same meaning.

According to the embodiment of the present invention, a semantic web standard ontology may be defined based on classes, objects, data, etc.

Referring to the top of FIG. 8, in the present invention, a class layer, an object layer, and a data layer may be defined, and a knowledge graph may be generated based on the class layer, the object layer, and the data layer.

A class is a concept of a set with data attributes and may correspond to a company (e.g., Samsung Electronics).

Data may include data about a company corresponding to a class such as fiscal year, address, company registration number, chief executive officer (CEO) name, and phone number.

An object may be information indicating a relationship between classes or a relationship between data. For example, the object may be information on a relationship between classes on the basis of supply chain, industry classification, etc. Assuming that there is a class of a company called “Samsung Electronics” and a class of a company called “KH Vatech,” “Samsung Electronics” has data attributes such as Jaeyong Lee for CEO and Suwon for address, and “Samsung Electronics” and “KH Vatech” may be linked based on an object attribute called “has supply chain.”

Referring to the bottom of FIG. 8, an internal data knowledge graph based on classes, data, and objects is disclosed.

“Apple” and “Microsoft” have a class called company, and “Steve Jobs,” “Bill Gates,” and “2011/10/05” may correspond to data. In addition, there may be objects such as “is a competitor of,” “is founded by,” and “is a friend of” that link classes or data.

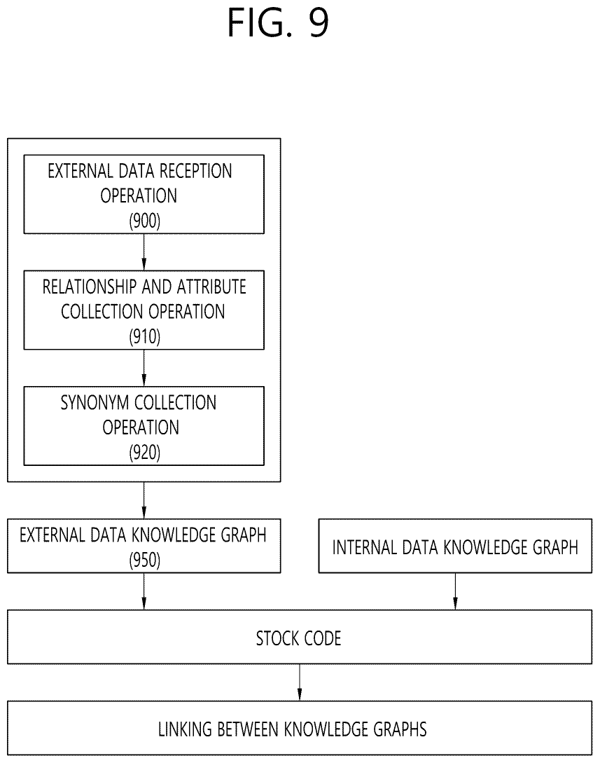

FIG. 9 is a conceptual diagram illustrating a knowledge graph according to the embodiment of the present invention.

In FIG. 9, a method of generating an external data knowledge graph is disclosed.

Referring to FIG. 9, an external data knowledge graph 950 may be constructed by collecting external data (e.g., Wikipedia data) and parsing the external data to extract attributes of headwords and information between the headwords. The headword may be an object for generating a knowledge graph, such as a company.

Data parsing may be performed in the following manner.
a) Data parsing
(1) External data reception operation 900

The candidate ticker determination unit may receive external data (e.g., Korean Wiki dump data) and ontology forms provided by an external data server (e.g., Wikipedia).

(2) Relationship and Attribute Collection Operation 910

By parsing only an infobox area including information from the external data, relationship and attribute information on headwords may be collected. The infobox area may be an area of the external data that includes relationship information and attribute information.

The relationship information may include an industry field, a founding date, a founder, a headquarters location, etc., and the attribute information may include electronic materials, Jan. 13, 1969, Byung-cheol Lee, Suwon-si, Gyeonggi-do, Republic of Korea, etc. The relationship information and the attribute information may be collected so that data such as Samsung Electronics, founder, Byung-cheol Lee may be collected.

Among the external data, classification information and mentioned external link information of headwords may be collected. For example, classification information of Samsung Electronics may be information on a category to classify Samsung Electronics, such as “Korea Exchange-listed company,” “London Stock Exchange-listed company,” “Semiconductor company,” “Robot company,” “Mobile phone manufacturer,” etc. The external link information may include information on external links related to Samsung Electronics (e.g., external links including information on Samsung Group).

Among the collected information, duplicate information may be removed based on an ontology (e.g., DB pedia ontology) for removing duplicate information.

(3) Synonym Collection Operation 920

Normalization of headwords (e.g., a process of removing parentheses and the like) may be performed, and information on homonyms may also be added. Various other search words that are searched for as a single target in an external data server and words that indicate the same target through mutual links may be determined as homonyms and collected as synonyms.

For example, “Samsung Galaxy Note 10.1” and “Galaxy Note 10.1” serving as a synonym thereof may be present as synonyms, and “iPhone SE 1^{st} generation,” “iPhone SE 2^{nd} generation,” and “iPhone SE 3^{rd} generation” may be present as synonyms for “iPhone SE.”

After the data parsing is performed through the above operations, information between headwords and attributes of headwords may be extracted by similarly utilizing relationships, attribute information, external links, synonyms, and the like of headwords in the infobox.

By extracting the information between the headwords, information on the company may be organized into classes, data, and objects to generate an external data knowledge graph 950.

Linking between knowledge graphs according to the embodiment of the present invention may be performed. For the linking between the knowledge graphs, linking may be performed based on stock codes. A stock code of a company corresponding to a knowledge graph of previously generated ontology data is compared with a stock code of a company corresponding to a newly generated knowledge graph, and when the stock codes are the same, the two companies may be automatically classified as the same company and the knowledge graphs may be linked. When knowledge graphs are present in constructed ontology data but there is no stock code, linking may not be performed. In this case, the linking between the knowledge graphs may be performed by building a relationship between companies in a relational database (RDB).

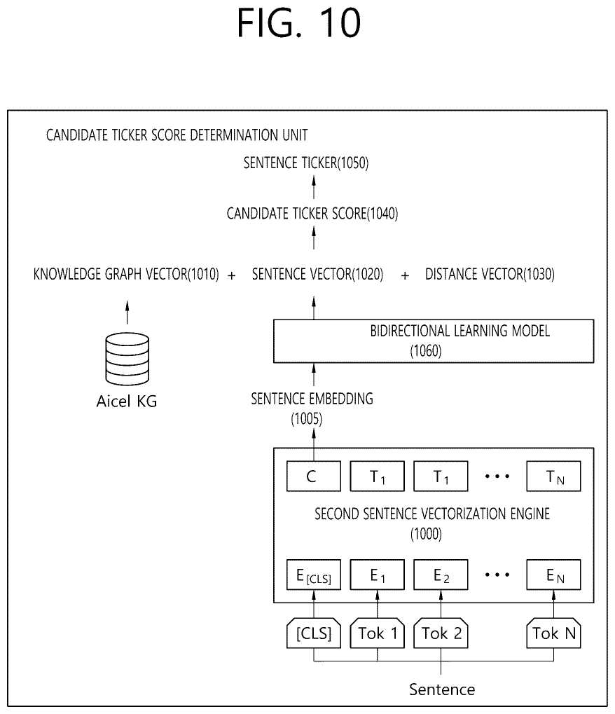

FIG. 10 is a conceptual diagram illustrating the operation of the candidate ticker score determination unit according to the embodiment of the present invention.

In FIG. 10, a specific operation of the candidate ticker score determination unit is disclosed.

Referring to FIG. 10, the candidate ticker score determination unit may be a model in which the entity name extraction unit is improved.

A second sentence vectorization engine 1000 used in the candidate ticker score determination unit may perform learning in a different manner from the first sentence vectorization engine.

When a first learning method (e.g., a masked language model (MLM)) in which empty (masked) words are predicted using preceding and following words and two consecutive sentences are given, the first sentence vectorization engine may perform learning on the basis of a second learning method (e.g., next sentence prediction (NSP)) in which whether the two sentences are correctly linked is predicted.

The second sentence vectorization engine 1000 may be trained using a replaced token detection (RTD) method in which a masked word is replaced with another word and then whether the word matches the original word is checked.

Determination of the sentence embedding value by the candidate ticker score determination unit may be performed in the following manner.

Types of tokens input to the second sentence vectorization engine 1000 include special tokens such as a CLS (start of full sentence) and a SEP (classification between sentences), and general tokens such as Tok 1 to Tok N. When the tokens Tok 1 to Tok N pass through the second sentence vectorization engine 1000, a Tn value indicating the meaning of the corresponding token in context is generated. However, when the CLS token passes through the second sentence vectorization engine 1000, the CLS token may be determined as C, which is a sentence embedding value encompassing all of the tokens Tok 1 to Tok N. Therefore, the sentence embedding value C derived from the CLS token is an embedding value for the input sentence itself.

For example, when tokenizing and embedding are performed on the sentence “Samsung Electronics' performance is 000,” T₁ to TN represent the meaning of the respective tokens (Tok 1 to Tok N), but the sentence embedding value C derived from the CLS token is a vector embedding of the sentence “Samsung Electronics' performance is 000.”

A sentence embedding value 1005 may be determined through the second sentence vectorization engine 1000, and the sentence embedding value 1005 may be generated as a sentence vector 1020 through a bidirectional learning model 1060.

The bidirectional learning model 1060 is a model that performs learning on the basis of forward and backward transmission of data. The bidirectional learning model 1060 has a structure composed of a total of two LSTMs by stacking one LSTM each in the forward and backward directions. Since the LSTM transmits two types of information, including information from a previous time point as well as information from the past, data of X₀ may be stably transmitted until a time point Hₜ₊₁. Since the LSTM transmits the data only in one direction from the time point X₀->Xₜ, the structure of the bidirectional learning model is a structure of adding the LSTM, which transmits data in backward direction from the time point Xₜ->X₀.

When only a forward LSTM is used in the sentence “To go camping and eat, the tools needed are bowls, spoons, chopsticks, burners, cookware, etc.,” the word “camping” may be used to identify the word “cookware,” but the word “cookware” may not be used to identify the word “camping.” Therefore, when the word “camping” is identified through a backward LSTM, the word “cookware” may be referred to.

C to Tn obtained through the second sentence vectorization engine 1000 may be generated as Y_{c} to Yₙ through the bidirectional learning model 1060. Y_{c} determined based on C, which is the sentence embedding value 1005, may be a sentence vector 1020 encompassing the embedding values of the entire token.

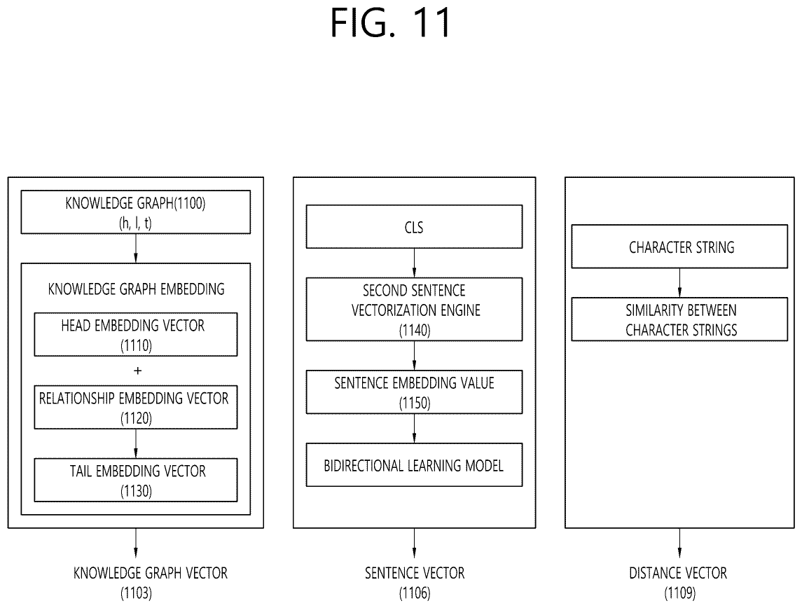

FIG. 11 is a conceptual diagram illustrating a method of determining, by the candidate ticker score determination unit according to the embodiment of the present invention, vector values.

In FIG. 11, a method of determining, by the candidate ticker score determination unit, a knowledge graph vector, a sentence vector, and a distance vector is disclosed.

Referring to FIG. 11, a knowledge graph vector 1103 may be obtained based on knowledge graph embedding (KGE) made by learning the knowledge graph 1100 described above.

The knowledge graph 1100 may be expressed in the form of a triple such as (h, l, t).

The triple (h, l, t) means a head, a relationship, and a tail, and means that the head and the tail have a specific relationship. For example, a triple (“Samsung Electronics,” “Vice Chairman,” “Jae-Yong Lee”) may include the meaning of “Samsung Electronics and Jae-Yong Lee have a relationship called Vice Chairman.”

In this way, KGE allows various relationships between the head and tail to be expressed in a low-dimensional vector space. Various methods may be used for KGE.

In the present invention, for KGE, a knowledge graph learning process in which a relationship embedding vector 1120 is added to a head embedding vector 1110 to generate a tail embedding vector 1130 may be performed. For example, assuming that “h1=Jae-yong Lee, h2=Eui-seon Chung, t1=Samsung, t2=Hyundai, and r1=CEO,” a process of learning a knowledge graph to get closer to h₁₊ᵣ=t₁ and h₂₊ᵣ=t₂ is performed.

The knowledge graph vector 1103 has vector values corresponding to candidate company names (or candidate tickers) determined based on KGE.

As described above, a sentence vector 1106 has vector values obtained by passing a sentence embedding value 1150 obtained by passing the CLS token through a second sentence vectorization engine 1140 once again through a bidirectional learning model.

A distance vector 1109 may be determined based on similarity between character strings. The similarity between the character strings may be determined using an algorithm that can find out how similar two given character strings A and B are. The similarity may be determined by calculating how many insertions and replacements are required for the character string A to become the same as the character string B. For example, assuming that there are a process and a professor, the process may be changed to the professor by replacing the 4th letter c of the character string A with f and inserting o and r in the last position. Since one substitution and two insertions are performed here, a distance between the process and the professor is 3. Using this algorithm, the distance vector may be determined by checking how close the candidate ticker is to the correct answer.

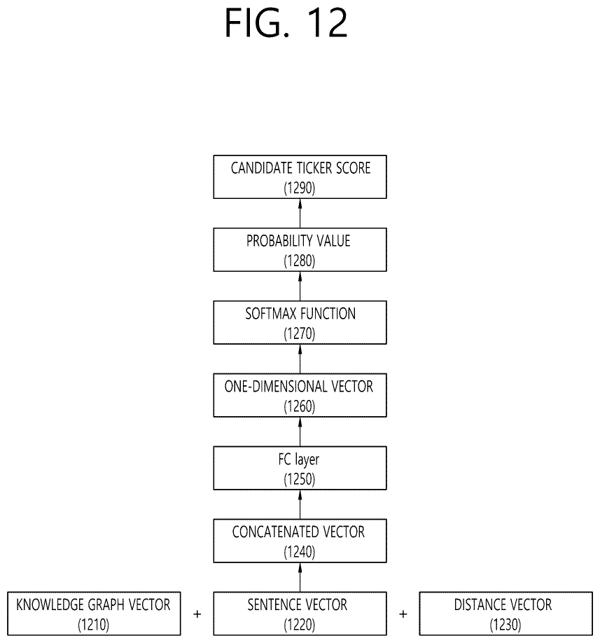

FIG. 12 is a conceptual diagram illustrating a method of determining candidate ticker scores according to the embodiment of the present invention.

In FIG. 12, a method of determining, by the candidate ticker score determination unit, candidate ticker scores is disclosed.

Referring to FIG. 12, a method of determining candidate ticker scores 1290 on the basis of a knowledge graph vector 1210, a sentence vector 1220, and a distance vector 1230 is disclosed.

The candidate ticker score determination unit may concatenate the knowledge graph vector 1210, the sentence vector 1220, and the distance vector 1230.

A dimension size of a concatenated vector 1240 obtained based on the concatenation of the knowledge graph vector 1210, the sentence vector 1220, and the distance vector 1230 is a value of the sum of a dimension size of the knowledge graph vector, a dimension size of the sentence vector, and a dimension size of the distance vector.

A vector value of the concatenated vector 1240 may be transmitted to a fully connected (FC) layer 1250, and the FC layer 1250 may reduce the vector value of the concatenated vector 1240 to one dimension. A one-dimensional vector 1260 may be extracted as a probability value 1280 on the basis of a Softmax activation function 1270.

The extracted probability value 1280 is a probability value for whether a specific candidate ticker is close to a correct answer, and the candidate ticker scores 1290 may be determined based on the probability value 1280. That is, the candidate ticker score 1290 that scores how close the candidate ticker is to the correct answer may be determined based on the probability value 1280 for at least one candidate ticker determined by the candidate ticker determination unit.

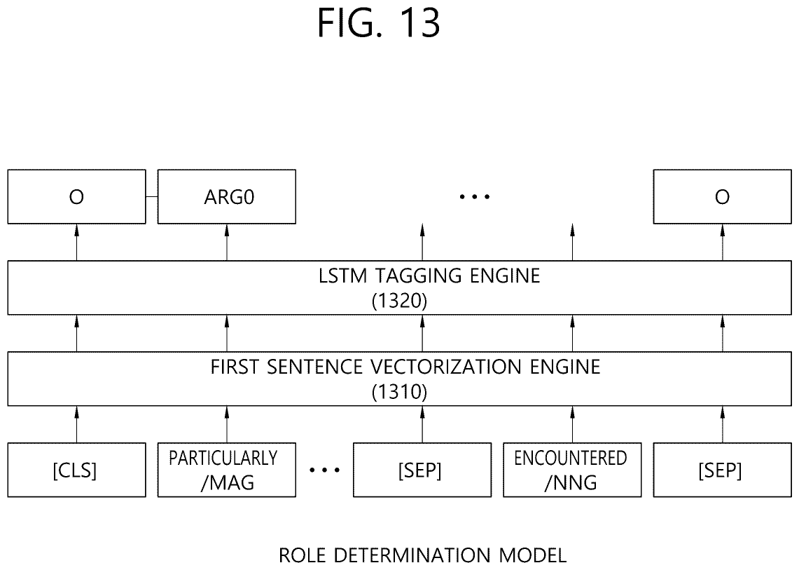

FIG. 13 is a conceptual diagram illustrating an operation of the role determination model according to the embodiment of the present invention.

In FIG. 13, a method of determining, by the role determination model of the news ticker determination unit, a ticker corresponding to news by classifying an evaluator and an evaluation target is disclosed.

Referring to FIG. 13, the role determination model may recognize a semantic relationship between a predicate included in a sentence and arguments that are modified by the predicate, and classify a role thereof. Through this, the purpose is to find semantic relationships such as “who, what, how, and why.” Even when a structure of the sentence is changed, the semantic arguments (actor and action subject) are maintained.

Therefore, determining a correct semantic translation plays a major role in understanding the meaning of the sentence and, further, in processing to understand the meaning of a document or conversation. For example, in the sentence “He showed his identification (ID) card to the police officer,” “he” may be classified as a subject (an object that performs, feels, and experiences the verb), “police officer” may be classified as a destination point (a result and destination point of the verb being performed), and “ID card” may be classified as an action subject (an object which the verb accompanies).

The role determination model first performs morphological analysis on the sentence using a morpheme analyzer. The morphological analysis is the understanding of a structure of various linguistic properties, including morphemes, roots, prefixes, suffixes, parts of speech, and the like.

Next, the tokens and results of the morpheme analysis may be bundled and transmitted to a first sentence vectorization engine 1310 used in the entity name extraction unit. That is, the sentence may be tokenized and transmitted to the first sentence vectorization engine 1310 and embedding may be performed thereon.

Thereafter, the tokenized sentence may be transmitted to an LSTM tagging engine 1320. The LSTM tagging engine 1320 may be an engine that performs LSTM-based learning on the tagging engine used in the entity name extraction unit. Classification of what the semantic role of the token is may be performed based on the LSTM tagging engine 1320.

Unlike in the entity name extraction unit, not only the token is included in an input value, but the morpheme analysis result is also transmitted, and thus it can be seen that what type of morpheme the token is.

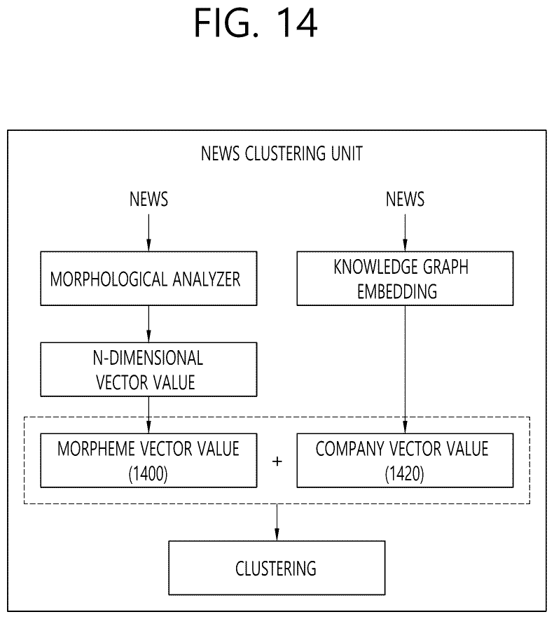

FIG. 14 is a conceptual diagram illustrating a clustering operation of the news clustering unit according to the embodiment of the present invention.

In FIG. 14, a clustering operation in which the news clustering unit removes duplicate news is specifically disclosed.

Referring to FIG. 14, the news clustering unit may generate entire sentences constituting news text in units of tokens using a morpheme analyzer.

Thereafter, the news clustering unit may delete particles (e.g., “eul,” “leul,” “i,” and “ga”) and ending expressions, and leave only a morpheme corresponding to a root.

The news clustering unit may express remaining morphemes, excluding the particles and the ending expressions, as n-dimensional vector values.

Specifically, vector values may be expressed by dividing each word into character-by-character n-grams. For example, assuming that “tomato juice” is divided based on n=3, vector values may be expressed as [“toma,” “tomato,” “mato ju,” “to juice,” “Juice”]. Languages with developed particles and endings, such as Korean, not only provide good performance, but also work well for transformation of various words because the languages are trained after splitting one word when divided into units of characters as described above.

After replacing the vector values for the remaining morphemes as described above, the vector value for the news may be determined by calculating an average value of all the vector values. The vector value of the news determined based on the remaining morphemes may be expressed in the form of a morpheme vector value 1400.

A company vector value 1420 is an embedding value of a company that matches the news determined in the KGE made by learning a knowledge graph. When there are a plurality of companies corresponding to the news, an average value of a plurality of company vector values 1420 of the plurality of companies may be a company vector value.

For example, assuming that vector values of the remaining morphemes present in pieces of news are [A, B, C, D] and vector values of the companies corresponding to the pieces of news are [X, Y], a morpheme vector value is (A+B+C+D)/4, and a company vector value is (X+Y)/2.

The morpheme vector value 1400 is an average value of meaningful morphemes present in a document, and the average value means that a morpheme vector value reflects more frequently mentioned words. For example, when the word “semiconductor” is mentioned frequently in news, the morpheme vector value 1400 of the news has a vector value close to “semiconductor.”

In the same way, using an average vector value of the companies to determine the company vector value 1420 of the news means that the company vector value 1420 reflects companies that are mentioned more in the news. When there is news related “Samsung Electronics” and “Hynix,” a company vector value of the news may represent the middle of the two companies.

The morpheme vector value 1400 for the news and the company vector value 1420 for the news, which are determined as described above, may be combined. An n-dimensional morpheme vector value 1400 and an m-dimensional company vector value 1420 may be combined and expressed as an (m+n)-dimensional vector value.

(M+n)-dimensional vector values for a plurality of pieces of news may form a cluster through clustering, and the formed cluster may be determined to be duplicate news.

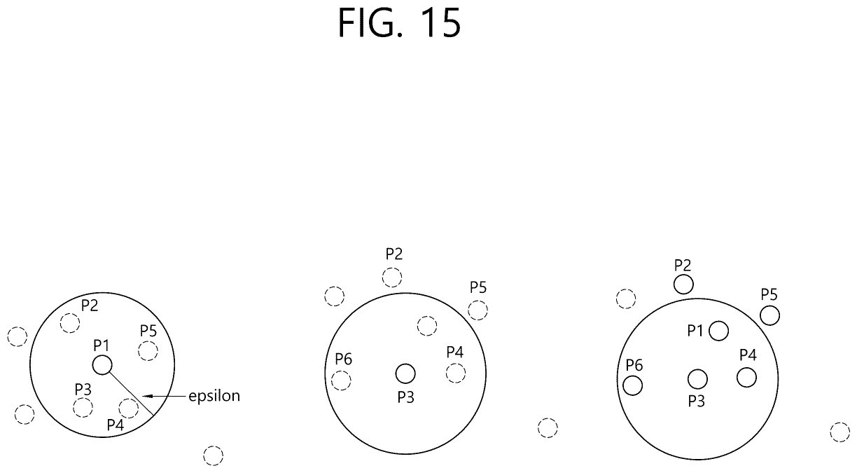

FIG. 15 is a conceptual diagram illustrating clustering according to the embodiment of the present invention.

In FIG. 15, a clustering method for clustering news is disclosed.

Referring to FIG. 15, in the present invention, when there are n points within a circle having a radius x based on a vector value, a method of recognizing the n points as one cluster may be used.

Since similar pieces of data are distributed close to each other, clustering based on such a radius may be performed. When there are m points (minimum points) within a circle having a radius of a distance epsilon (eps) from a center point P, the m points may be recognized as one cluster and a cluster may be formed.

For example, when M is set to 4, since five pieces of news P2, P3, P4, and P5 are present within the circle having the radius of the eps based on news P1, the pieces of news P1, P2, P3, P4, and P5 may be recognized as a first cluster, which is one cluster.

Further, since there are four pieces of news P3, P4, P1, and P6 within the circle having the radius of the eps based on news P3, the four pieces of news P3, P4, P1, and P6 may be recognized as a second cluster, which is one cluster.

Further, since pieces of news P1 and P3 are present in one cluster, the first cluster and the second cluster may be grouped together to form a third cluster. The pieces of news P1, P2, P3, P4, P5, and P6 included in the third cluster may be grouped as one news cluster.

In the same way as described above, pieces of duplicate news may be grouped into one cluster.

The embodiments of the present invention described above may be implemented in the form of program instructions that can be executed through various computer units and recorded on computer readable media. The computer readable media may include program instructions, data files, data structures, or combinations thereof. The program instructions recorded on the computer readable media may be specially designed and prepared for the embodiments of the present invention or may be available instructions well known to those skilled in the field of computer software. Examples of the computer readable media include magnetic media such as a hard disk, a floppy disk, and a magnetic tape, optical media such as a compact disc read only memory (CD-ROM) and a digital video disc (DVD), magneto-optical media such as a floptical disk, and a hardware device, such as a ROM, a RAM, or a flash memory, that is specially made to store and execute the program instructions. Examples of the program instruction include machine code generated by a compiler and high-level language code that can be executed in a computer using an interpreter and the like. The hardware device may be configured as at least one software module in order to perform operations of embodiments of the present invention and vice versa.

While the present invention has been described with reference to specific details such as detailed components, specific embodiments and drawings, these are only examples to facilitate overall understanding of the present invention and the present invention is not limited thereto. It will be understood by those skilled in the art that various modifications and alterations may be made.

Therefore, the spirit and scope of the present invention are defined not by the detailed description of the present invention but by the appended claims, and encompass all modifications and equivalents that fall within the scope of the appended claims.

What is claimed is:

1. A method of determining a candidate company related to news, comprising:
determining, by a news ticker mapping apparatus, an entity name for news; and
determining, by the news ticker mapping apparatus, a candidate ticker on the basis of the entity name.

2. The method of claim 1, wherein the entity name includes a first entity name and a second entity name, and
the candidate ticker is determined based on a keyword determined based on the first entity name and info determined based on the second entity name.

3. The method of claim 2, wherein the candidate ticker is determined based on synonym expansion for the keyword and relationship information-based expansion for the info, and
the relationship information-based expansion is determined based on a knowledge graph.

4. A news ticker mapping apparatus for determining a candidate company related to news, comprising:
an entity name extraction unit configured to determine an entity name for news; and
a candidate ticker determination unit configured to determine a candidate ticker on the basis of the entity name.

5. The news ticker mapping apparatus of claim 4, wherein the entity name includes a first entity name and a second entity name, and
the candidate ticker is determined based on a keyword determined based on the first entity name and info determined based on the second entity name.

6. The news ticker mapping apparatus of claim 5, wherein the candidate ticker is determined based on synonym expansion for the keyword and relationship information-based expansion for the info, and
the relationship information-based expansion is determined based on a knowledge graph.
